(19) United States
(12) Patent Application Publication
(10) Pub. No.: US 2024/0029578 A1
(43) Pub. Date: Jan. 25, 2024

(54) Information Processing Method, Questionnaire Aggregation Apparatus, and Information Recording Medium

(71) Applicant: Konica Minolta, Inc., Tokyo (JP)

(72) Inventor: Junichi FURUKAWA, Tokyo (JP)

(73) Assignee: Konica Minolta, Inc., Tokyo (JP)

(21) Appl. No.: 18/356,559

(22) Filed: Jul. 21, 2023

(30) Foreign Application Priority Data
Jul. 21, 2022 (JP) 2022-116322

(51) Int. Cl. G09B 7/06; G06F 16/332

(52) U.S. Cl. CPC G09B 7/06; G06F 16/3329

(57) ABSTRACT

An information processing method to be executed by a computer comprises: accessing a questionnaire answer consisting of one or more options selected from a plurality of options prepared in advance as answers to each of a plurality of questions, and information recorded as a selection manner in which the one or more options are selected; and calculating a degree of importance of each of the selected one or more options, based on the information recorded as the selection manner.

### CROSS-REFERENCE TO RELATED APPLICATIONS

This application claims priority to Japanese Patent Application No. 2022-116322, filed on Jul. 21, 2022, the disclosure of which is incorporated herein by reference in its entirety.

### BACKGROUND

### Technological Field

The present disclosure relates to information processing, and more specifically, to a technology for calculating the degree of importance of an answer to a question.

### Description of the Related Art

In recent years, Web questionnaires have been widely implemented, and the number of opportunities to visualize an index or a graph of a purpose from the results of answer has increased, and there is a demand for improvement of accuracy and reliability of the questionnaires. As a question form of the questionnaire, a multiple-option question providing a plurality of answers to be selected from a plurality of options is widely used due to advantages such as easy aggregation and easy response by a respondent. In addition, a question in a matrix form in which an evaluation scale (for example, options such as 1 to 10) is provided for each option is often used.

On the other hand, if the matrix becomes too large, a burden on the respondent becomes large, and it is a problem that the number of times of withdrawal increases and an answer completion rate deteriorates. Therefore, a technology for reading an evaluation scale (degree of importance) from an answer result without using a matrix form in a multiple-option question is required.

With respect to the evaluation of a questionnaire result, for example, Japanese Laid-Open Patent Publication No. 2018-106275 discloses a technology of “comprehensively evaluating a result of a questionnaire survey on the basis of evaluation of each of answer options weighted so as to be preferable for a question with a high degree of importance”. In particular, it discloses “a questionnaire support device includes a storage unit that stores question information in which a question, an emphasis flag indicating whether or not the question has a high degree of importance, and an answer option are associated with each other, and answer option information in which answer options and evaluation scores are associated with each other, and an evaluation unit that calculates a total evaluation score indicating a total evaluation of answer results to a questionnaire based on the evaluation scores associated with the selected answer options, wherein the evaluation unit calculates the total evaluation score as a minimum evaluation score in a case where the selected answer option is not an answer option having the highest evaluation score among the evaluation scores associated with the plurality of answer options associated with the question, for the question associated with an emphasis flag indicating a high degree of importance” (See Abstract).

### SUMMARY

However, in the above-described technology, since the evaluation score of an option is determined based on the degree of importance determined by the creator of the questionnaire, the evaluation score does not reflect the degree of importance felt by the respondent. Therefore, there is a need for a technique for deriving a result in which the degree of importance felt by the respondent is reflected.

The present disclosure has been made in view of the above-described background, and according to an aspect, there is disclosed a technique of obtaining an answer result in which the degree of importance felt by a respondent is added to each of one or more options selected at the time of answering a multiple-option question.

To achieve at least one of the abovementioned objects, according to an aspect of the present invention, an information processing method to be executed by a computer reflecting one aspect of the present invention comprises: accessing a questionnaire answer consisting of one or more options selected from a plurality of options prepared in advance as answers to each of a plurality of questions, and information recorded as a selection manner in which the one or more options are selected; and calculating a degree of importance of each of the selected one or more options, based on the information recorded as the selection manner.

To achieve at least one of the abovementioned objects, according to an aspect of the present invention, a questionnaire aggregation apparatus reflecting one aspect of the present invention comprises: a memory to store a plurality of instructions; and a processor to execute the plurality of instructions. The plurality of instructions, when executed by the processor, causing the processor to perform: accessing a questionnaire answer consisting of one or more options selected from a plurality of options prepared in advance as answers to each of a plurality of questions, and information recorded as a selection manner in which the one or more options are selected; and calculating a degree of importance of each of the selected one or more options, based on the information recorded as the selection manner.

To achieve at least one of the abovementioned objects, according to an aspect of the present invention, a non-transitory computer-readable information recording medium storing a plurality of instructions reflecting one aspect of the present invention, the plurality of instructions, when executed by a processor, causing the processor to perform: accessing a questionnaire answer consisting of one or more options selected from a plurality of options prepared in advance as answers to each of a plurality of questions, and information recorded as a selection manner in which the one or more options are selected; and calculating a degree of importance of each of the selected one or more options, based on the information recorded as the selection manner.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating an example of a system 100 for evaluating online questionnaires according to an aspect.

FIG. 2 is a block diagram showing a hardware configuration of a computer system 200 that realizes the terminals 110 and 120 or the questionnaire aggregation apparatus 130.

FIG. 3 is a block diagram illustrating the functional configuration of the questionnaire aggregation apparatus 130.

FIG. 4 is a diagram illustrating an aspect of data storage in the hard disk 5 functioning as the questionnaire storage unit 310 of the questionnaire aggregation apparatus 130.

FIG. 5 is a diagram illustrating an aspect of data storage in the hard disk 5 functioning as the answer storage unit 340 of the questionnaire aggregation apparatus 130.

FIG. 6 is a diagram showing an example of the result of the questionnaire aggregated by the questionnaire aggregation apparatus 130.

FIG. 7 is a flowchart representing a portion of the processing performed by the CPU 1 of computer system 200 when recording the answers to a questionnaire.

FIG. 8 is a flowchart representing a portion of the processing performed by the CPU 1 of computer system 200 to evaluate a questionnaire.

FIG. 9 is a diagram illustrating transition of screens displayed on the terminal 120 used by a user of the questionnaire aggregation service.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments of the present invention will be described with reference to the drawings. In the following description, the same components are denoted by the same reference numerals. Their names and functions are also the same. Therefore, detailed description thereof will not be repeated.

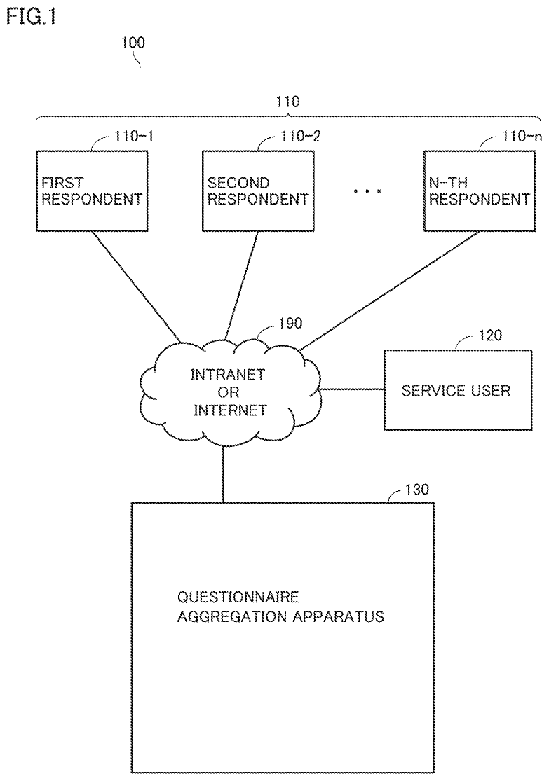

A manner in which a questionnaire is conducted will be described with reference to FIG. 1. FIG. 1 is a diagram illustrating an example of a system 100 that conducts questionnaires conducted online and aggregates and evaluates the results of answer according to an aspect. The system 100 includes terminals 110-1, 110-2, . . . 110-n used by first to n-th respondents, respectively, and a questionnaire aggregation apparatus 130. The terminals 110-1, 110-2, . . . 110-n and the questionnaire aggregation apparatus 130 are communicably connected to each other via a network 190 implemented as an intranet or the Internet. The terminals 110-1, 110-2, and 110-n may be collectively referred to as terminal 110.

A terminal 120 used by a user of the questionnaire service is further connected to the network 190. The user can check the aggregation result by the questionnaire aggregation apparatus 130 on the terminal 120.

In a certain aspect, the questionnaire aggregation apparatus 130 performs a questionnaire as an information processing apparatus, receives an answer to the questionnaire, and calculates a degree of importance from the answer. More specifically, the questionnaire aggregation apparatus 130 transmits a questionnaire to each terminal 110 and displays questions and options constituting the questionnaire on the display of the terminal 110. Each respondent inputs an answer to the questionnaire from a terminal 110 which can be used by each respondent. The questionnaire aggregation apparatus 130 aggregates the answers and displays the aggregation result or outputs the aggregation result to another information processing apparatus.

In another aspect, a plurality of respondents may respond to a questionnaire using one terminal 110. In this case, for example, by individually logging in to an account owned by each respondent and answering a questionnaire presented in the account, a plurality of respondents can answer the questionnaire while sharing one terminal 110.

[Configuration of Computer System]

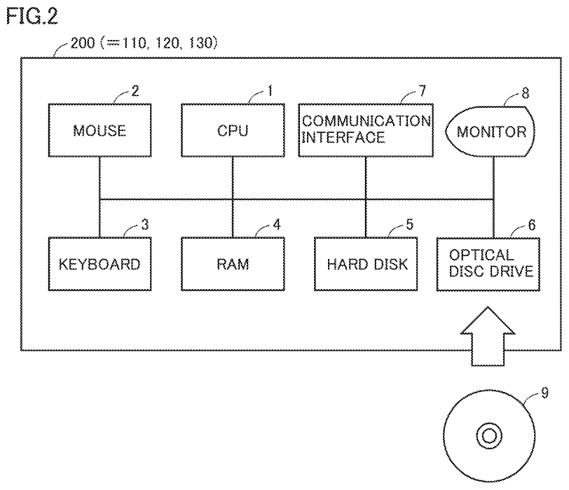

The configuration of the information processing apparatus constituting the system 100 will be described with reference to FIG. 2. FIG. 2 is a block diagram showing a hardware configuration of a computer system 200 that realizes the terminals 110 and 120 or the questionnaire aggregation apparatus 130.

The computer system 200 includes, as main constituent elements, a central processing unit (CPU) 1 that executes a program, a mouse 2 and a keyboard 3 for receiving an input of an instruction from a user of the computer system 200, a RAM 4 for storing, in a volatile manner, data generated by execution of a program by the CPU 1, or data input via the mouse 2 or the keyboard 3, a hard disk 5 for storing data in a nonvolatile manner, an optical disc drive 6, a communication interface (I/F) 7, and a monitor 8. These components are connected to each other via a data bus. A compact disc-read only memory (CD-ROM) 9 and other optical discs can be mounted on the optical disc drive 6.

The processing in the computer system 200 is realized by software executed by each piece of hardware and a CPU 1. Such software may be stored in the hard disk 5 in advance. Further, the software may be stored in a CD-ROM 9 or other recording media and distributed as a computer program. Alternatively, the software may be provided as a downloadable application program by an information provider connected to the so-called Internet. Such software is temporarily stored in the hard disk 5 after being read from the recording medium by the optical disc drive 6 or another reading device, or after being downloaded via the communication interface 7. The software is read from the hard disk 5 by the CPU 1 and is stored in the RAM 4 in the form of an executable program. The CPU 1 executes the program.

Each component constituting the computer system 200 shown in FIG. 2 is a general component. Therefore, it can be said that one of the essential parts of the technical idea according to the present disclosure is software stored in the RAM 4, the hard disk 5, a CD-ROM 9, or another recording medium, or software downloadable via a network. The data recording medium may include a non-transitory computer-readable data recording medium. Since the operation of each hardware component of the computer system 200 is well known, the detailed description thereof will not be repeated.

The recording media is not limited to CD-ROM, FD (Flexible Disk), and hard disk, but may be a solid state drive (SSD), magnetic tape, optical discs (MO (Magnetic Optical Disc)/MD (Mini Disc)/DVD (Digital Versatile Disc)), IC (Integrated Circuit) cards (including memory card), optical card, Mask ROM, EPROM (Electronically Programmable Read-Only Memory), EEPROM (Electronically Erasable Programmable Read-Only Memory), and a semiconductor memory such as a flash ROM carrying a program in a fixed manner.

Here, the program includes not only a program directly executable by the CPU but also a program in a source program format, a compressed program, an encrypted program, and the like.

The computer system 200 can be implemented as a notebook, desktop, or other type of computer apparatus, or a portable information communication terminal such as a smartphone or tablet terminal.

[Functional Configuration]

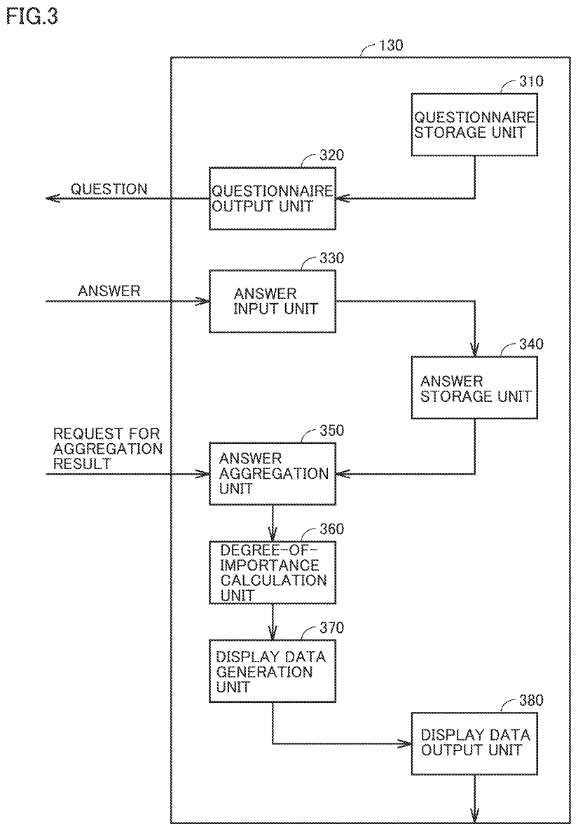

The configuration of the questionnaire aggregation apparatus 130 will be further described with reference to FIG. 3. FIG. 3 is a block diagram illustrating the functional configuration of the questionnaire aggregation apparatus 130. The questionnaire aggregation apparatus 130 includes a questionnaire storage unit 310, a questionnaire output unit 320, an answer input unit 330, an answer storage unit 340, an answer aggregation unit 350, a degree-of-importance calculation unit 360, a display data generation unit 370, and a display data output unit 380.

The questionnaire storage unit 310 holds a questionnaire created by a provider or the like that provides an online questionnaire service.

The questionnaire output unit 320 reads a questionnaire from the questionnaire storage unit 310 and causes a client terminal (user terminal) accessing the questionnaire aggregation apparatus 130 to display the questionnaire.

The answer input unit 330 receives the input of an answer inputted in a client terminal and stores the answer in the answer storage unit 340.

The answer storage unit 340 is implemented by a nonvolatile storage such as a hard disk, a solid-state drive (SSD) or the like. In another aspect, the answer storage unit 340 may be configured as a storage device outside the questionnaire aggregation apparatus 130, for example, a recording area on a cloud.

The answer aggregation unit 350 aggregates the answers to the questionnaire based on an instruction provided to the questionnaire aggregation apparatus 130. The instruction may include, for example, a request for an aggregation result from a client who has requested the questionnaire, a request from an administrator of the questionnaire aggregation apparatus 130, and the like.

The degree-of-importance calculation unit 360 calculates the degree of importance of each option using the result of the aggregation performed by the answer aggregation unit 350.

The display data generation unit 370 generates data for causing the client terminal to display a questionnaire result corresponding to the degree of importance.

The display data output unit 380 outputs the data generated by the display data generation unit 370.

In a certain aspect, the CPU 1, as answer aggregation unit 350, accesses a questionnaire answer including one or more options selected from a plurality of options prepared in advance as answers to each of a plurality of questions, and information recorded as a selection manner in which the one or more options are selected. The CPU 1 serving as the degree-of-importance calculation unit 360 calculates the degree of importance of each of the selected one or more options based on the information recorded as the selection manner. Thus, the questionnaire aggregation apparatus 130 can derive a result in which the degree of importance felt by the respondent is taken into consideration.

In an aspect, the information recorded as the selection manner is a selection order in which one or more options are selected. When calculating the degree of importance, the CPU 1 calculates the degree of importance such that the degree of importance of an option selected earlier is higher than the degree of importance of an option selected later. For example, in a case where there are options, CPU 1 sets the degree of importance of the option first selected by the respondent to and thereafter sets the degree of importance to 9, 8 . . . 1. When the respondent sees the options, it is conceivable that the respondent selects from among the options in descending order of priority (degree of importance), and thus the questionnaire aggregation apparatus 130 measures the order of selection by a click operation or the like on the terminal 110 of the respondent, and derives the degree of importance according to a rule prepared in advance so that the degree of importance becomes higher in accordance with the order.

In one aspect, the information recorded as the selection manner is the time taken for each of one or more options to be selected. When calculating the degree of importance, the CPU 1 calculates the degree of importance such that the degree of importance of an option having a shorter time to be taken is higher than the degree of importance of an option having a longer time to be taken. For example, if there are 10 options, CPU 1 sets the degree of importance to 10 for the option selected in the shortest time, and then sets the degree of importance successively to 9, 8 . . . 1 for the other options, respectively. The questionnaire aggregation apparatus 130 calculates the degree of importance according to a rule prepared in advance so that the earlier the time is, the higher the degree of importance is, because it is considered that when the respondent looks at the options, the respondent quickly selects the option having a high priority (degree of importance) from the options, and it takes time to select the option if the respondent hesitates to select the option.

In one aspect, when calculating the degree of importance, the CPU 1 sets the degree of importance of the option selected after the selection and the cancellation of the selection are repeated, lower than the degrees of importance of other selected options. For example, the CPU 1 gives the option finally selected after the selection and the cancellation of the selection, either a degree of importance set higher than that of the other options or a degree of importance set lower than that of the other options. In a case where the respondent is uncertain about whether to select an option or not, it is conceivable that an action of selecting or not selecting is repeated, and in a case where such an action is often performed, the questionnaire aggregation apparatus 130 derives the degree of importance according to a rule prepared in advance so that the degree of importance of the option decreases.

In one aspect, when the CPU 1 calculates the degree of importance, if each of the plurality of options is selected in the order of arrangement, it does not calculate the degree of importance of the selected option. For example, when the options are selected in order from top to bottom, from bottom to top, from left to right, or from right to left, the CPU 1 does not calculate the degree of importance of the option because the option is not a target of importance calculation.

In an aspect, the CPU 1 serves as the display data generation unit 370 to reflect the degree of importance in a questionnaire answer. The CPU 1 serves as the display data output unit 380 to output the questionnaire answer reflecting the degree of importance to the administrator's terminal 120.

In one aspect, the CPU 1 displays each of the plurality of questions and a plurality of options prepared in advance as answers to each question on the terminals accessing the computer. The CPU 1 receives, from the terminal, information recorded as a selection manner in which one or more options are selected.

In still another aspect, the CPU 1 may display a question for which all options are displayed on a single screen, on the terminal 110. Since there is a tendency to select each page when a questionnaire page is switched in the middle of options, the CPU 1 causes the terminal 110 to display a question for which all options are included in one screen.

In another aspect, the CPU 1 causes the terminal 110 to display questions with options displayed in a plurality of rows. In a case where the options are displayed in one row, in particular, in a case where the number of options is large, there is a strong tendency to perform selection in the order of selection, and therefore, in order to obtain a more accurate result, questions of for which options are displayed in a plurality of rows may be displayed.

In another aspect, the CPU 1 causes the terminal 110 to display questionnaires in a web format. From the viewpoint of measuring the order of selecting options and the time required for selection, the CPU 1 makes a questionnaire in a web format rather than a format in which a questionnaire in a file format is transmitted and an answer in a file format is received.

In another aspect, even when only one of the options is selected, there may be a case where the degree of importance of the selected option is desired to be measured. In this case, for example, the questionnaire aggregation apparatus 130 may measure the elapsed time immediately after answering the immediately preceding question and calculate the degree of importance in accordance with the time taken for an option to the question to be selected.

Furthermore, when the question is the first question on the screen, the questionnaire aggregation apparatus 130 may measure an elapsed time immediately after the screen is displayed and calculate the degree of importance according to the time taken for an option to be selected.

In another aspect, in a case where the time taken for an option to be selected is too short, it is considered that the respondent has answered unthoughtfully. Therefore, if the time is shorter than a certain threshold, the questionnaire aggregation apparatus 130 may not calculate the degree of importance in such a case.

[Data Structure]

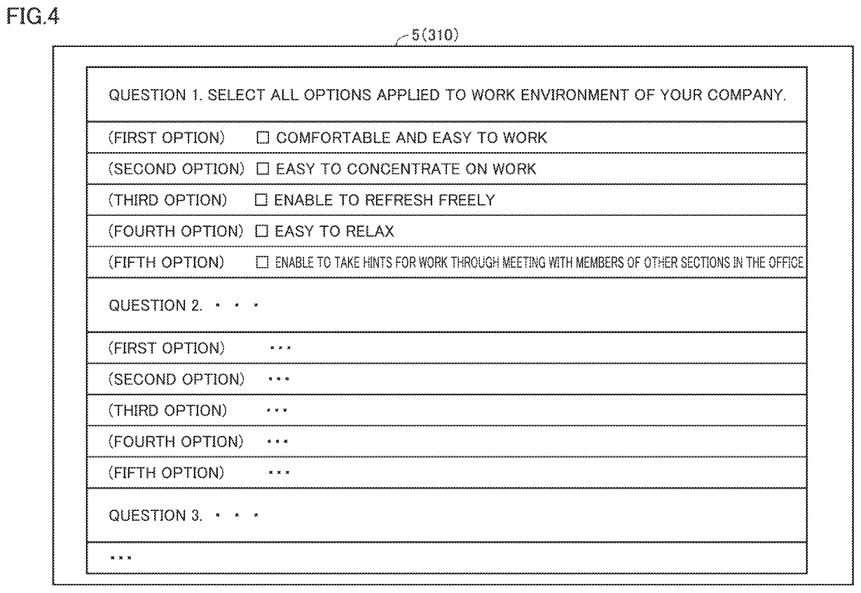

A data structure of the questionnaire aggregation apparatus 130 will be described with reference to FIGS. 4 to 6. FIG. 4 is a diagram illustrating an aspect of data storage in the hard disk 5 functioning as the questionnaire storage unit 310 of the questionnaire aggregation apparatus 130.

The hard disk 5 holds one or more questionnaires. Each questionnaire includes one or more questions. Each question has a plurality of options. The number of options is not particularly limited.

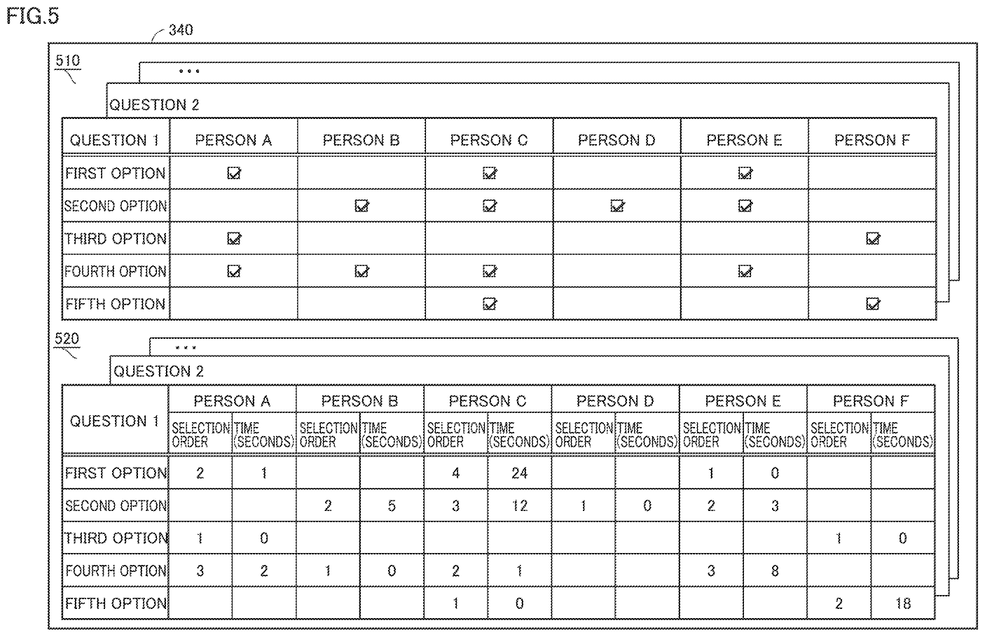

FIG. 5 is a diagram illustrating an aspect of data storage in the hard disk 5 functioning as the answer storage unit 340 of the questionnaire aggregation apparatus 130.

The hard disk 5 holds tables 510 and 520. Table 510 holds a result of an answer by each respondent. The answer result includes one or more options. Table 520 holds the order of selection by a respondent and the time required for selecting an option. The time taken for selecting an option is indicated, for example, as the time taken to select the option from when a list of options is displayed on the monitor of the terminal of the respondent, or as the time taken to select each of the second and subsequent options from when the first option is selected.

In the example illustrated in Table 520 of FIG. 5, the time required for selecting each of the second and subsequent options, from the time when the first option is selected from among one or more options, is illustrated. Therefore, for the first selected option, the required time is 0 (second) and, for the second and subsequently selected options each, the elapsed time from the first selected option is shown as the required time.

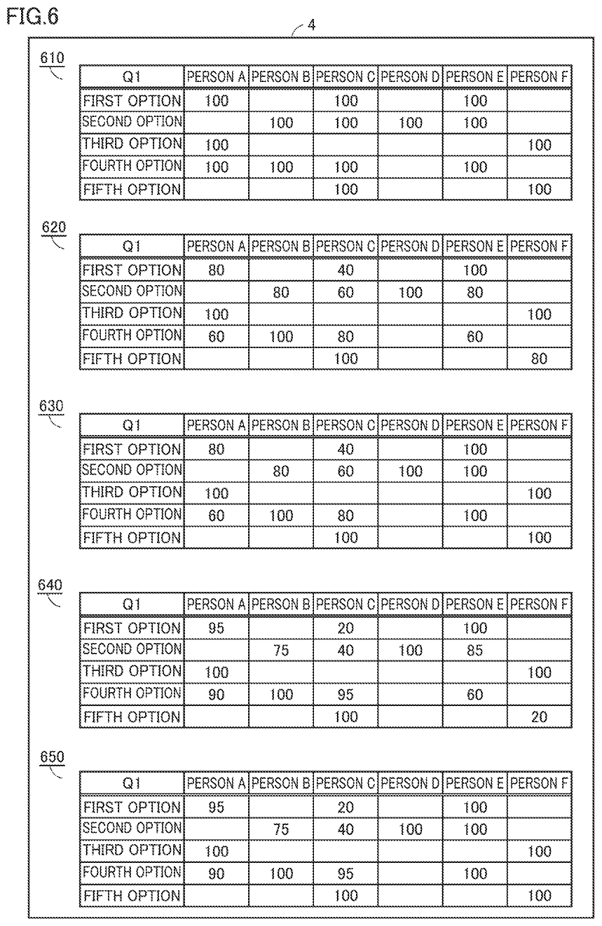

FIG. 6 is a diagram showing an example of the result of the questionnaire aggregated by the questionnaire aggregation apparatus 130.

In an aspect, the computer system 200 functioning as the questionnaire aggregation apparatus 130 aggregates the answers to the questionnaire based on the received request for aggregation result and generates data in the RAM 4.

For example, Table 610 exemplifies a numerical value (x=100) assigned to the selected option in a case where the degree of importance is not set for each option. The above numerical value is given by way of example, and other values may also be used.

<Selection Order>

Table 620 exemplifies the degree of importance in a case where the rule of calculating the degree of importance according to the order in which the options are selected is applied. That is, in a case where a plurality of options is selected as answers, it is assumed that the degree of importance of the option selected first is the highest and the degree of importance of the option selected last is the lowest. Therefore, a rule is applied such that the degree of importance to be calculated becomes lower as the order of selection becomes later. As an example, a linear function with a negative slope is used.

In the example illustrated in Table 620, the degree of importance (y) is calculated by using the following expression with the order of selection (selection order) as x.

y=−20x+120 (1)

The numerical values of the constant and the slope in Expression (1) may be different for each question constituting the questionnaire, or the same constant and slope may be employed.

<Case of Options in Order of Arrangement>

Persons E and F select answers in the order of arrangement of the options as apparent from Table 520 in FIG. 5. Therefore, in this case, the same degree of importance may be given to the selected options on the assumption that the degrees of importance of the respective options are substantially the same.

For example, as illustrated in Table 630, in another aspect, the same degree of importance (=100) may be given to options selected by Persons E and F.

Note that the numerical value of the degree of importance in this case may be different for each question configuring the questionnaire, or the same numerical value may be adopted. For example, a numerical value indicating the degree of importance may be set in accordance with the weight of each question.

<Elapsed Time>

Table 640 exemplifies the degree of importance in a case where the rule of calculating the degree of importance according to the time taken to select an option (elapsed time) is applied. In this case, a linear function having a negative slope is used such that the degree of importance decreases as the elapsed time increases. For example, the degree of importance (y) is calculated using Expression (2) using the elapsed time (x), for example.

y=100−5x (2)

However, in the case of Expression (2), when the elapsed time exceeds 20 seconds, the degree of importance (y) becomes a negative value. For example, the degree of importance of the first option selected by Person C is −20. An option with a long, elapsed time may be lower in the degree of importance for the respondent but is different from an option that was not selected, in that it was selected. Therefore, in order to clarify the difference from the non-selected option (=degree of importance=0), it is desirable that the degree of importance of the selected option does not have a negative value.

For example, a fixed (=minimum) degree of importance may be given to a selected option with a fixed elapsed time or longer. In this case, Expression (2) is separated according to the elapsed time into Expressions (3-1) and (3-2).

In the case of x≤15: y=100−5x (3-1)

In the case of x>15: y=20 (3-2)

Note that in another aspect, the value of the constant (=100) in Expression (2) may be increased or decreased, depending on the length of the recorded elapsed time. That is, the value of the constant may at least be set so that the degree of importance of the option with the longest elapsed time (=the option selected lastly) is not a negative value.

Furthermore, in addition to the time taken for an option to be selected, the order in which options are selected may be considered. For example, as described above, Persons E and F select answers in the order in which the options are arranged, as is clear from Table 520 in FIG. 5. Therefore, as shown in Table 650, when the answers of Persons E and F are selected in the order of arrangement of the options, the same degree of importance (=100) may be given to the options as in the case of Table 630.

[Control Structure]

<Aggregation of Answers to Questionnaire>

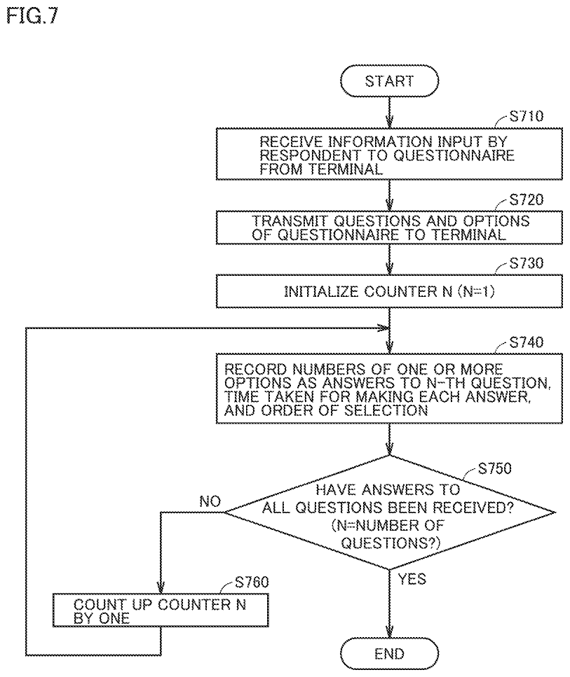

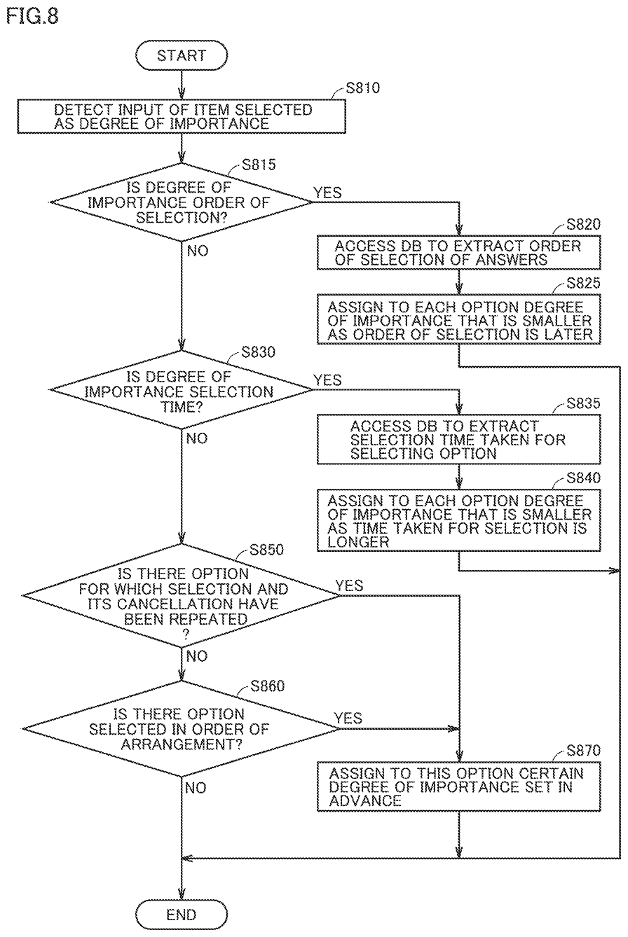

A control structure of the questionnaire aggregation apparatus 130 will be described with reference to FIGS. 7 and 8. FIG. 7 is a flowchart representing a portion of the processing performed by the CPU 1 of the computer system 200 when recording the answers to a questionnaire. The processing of FIG. 7 is executed in a case where an answer to a questionnaire is received from a terminal of one respondent. When answers to a questionnaire are received from terminals of a plurality of respondents, the process shown in FIG. 7 is executed for each communication session established for each respondent.

In a step S710, the CPU 1 receives respondent information inputted by a respondent to a questionnaire from a terminal used by the respondent, before executing the questionnaire. The respondent information is information such as a gender, an age, an occupation, and a business type of the respondent, and is information for classifying the respondent by its attribute without identifying the individual.

In step S720, the CPU 1 transmits the questions and options of the questionnaire to the terminal 110 of the respondent. In an aspect, the CPU 1 can collectively transmit all the questions in the questionnaire and the corresponding options to the terminal 110. In another aspect, the CPU 1 may sequentially transmit questions and corresponding options to the terminal.

In step S730, the CPU 1 initializes a counter N (N=1).

In step S740, the CPU 1 records, in the question, the number of one or more options as an answer to the N-th question, the time taken for making each answer, and the order of selection.

In step S750, the CPU 1 determines whether or not answers to all questions have been received. This determination is performed based on, for example, whether or not the value of the counter N matches the number of questions (N) in the questionnaire. When the CPU 1 determines that the answers to all the questions have been received (YES in step S750), the process is terminated. Otherwise (NO in step S750), CPU 1 switches the control to step S760.

In step S760, the CPU 1 counts up the counter N by one. Thereafter, the CPU 1 returns the control to step S740 and records, for the next question, the number of an option, a time taken for answering, and the order of selection.

<Calculation of the Degree of Importance>

FIG. 8 is a flowchart representing a portion of the processing performed by the CPU 1 of the computer system 200 to evaluate a questionnaire.

In step S810, the CPU 1 detects an input of an item selected as a degree of importance. In the present embodiment, either the selection order or the selection time is exemplified as the target of the degree of importance, but other criteria can be the degree of importance.

In step S815, the CPU 1 determines whether or not the degree of importance selected by a user (e.g., a user of the service provided by the questionnaire aggregation apparatus 130, that is, a host of the questionnaire) is “order of selection”. Upon determination that the selected degree of importance is the order of selection (YES in step S815), the CPU 1 switches the control to step S820. Otherwise (NO in step S815), the CPU 1 switches the control to step S830.

In step S820, the CPU 1 accesses the database (Table 520 in FIG. 5) stored in the hard disk and reads the order of selection of answers obtained for the questionnaires that have already been conducted.

In step S825, the CPU 1 assigns a degree of importance that is smaller as the order of selection is later, to one or more options selected as answers (Expression (1)).

In step S830, the CPU 1 determines whether or not the selected degree of importance is “selection time” (the time taken to select the option). When the CPU 1 determines that the selected degree of importance is “selected time” (YES in step S830), it switches the control to step S835. Otherwise (NO in step S830), CPU 1 switches the control to step S850.

In step S835, the CPU 1 accesses the database (Table 520 in FIG. 5) stored in the hard disk and reads the selection time (seconds) of the answer. For example, in a case where the respondent is Person A, the CPU 1 reads out the selection time (1 second) of the first option, the selection time (0 second) of the third option, and the selection time (2 seconds) of the fourth option for Question 1.

In step S840, the CPU 1 assigns a degree of importance, which decreases as the selection time increases, to one or more options selected as answers (Expression (2)).

In step S850, the CPU 1 determines whether there is an option for which selection and cancellation of the selection have been repeated. This determination is performed based on, for example, a history of selection and cancellation of an option that can be an answer to a certain question. When the CPU 1 determines that there is the option (YES in step S850), it switches the control to step S855. Otherwise (NO in step S850), the CPU 1 switches the control to step S860.

In step S860, the CPU 1 determines whether there is an option selected in the order of arrangement. When the CPU 1 determines that there is an option selected in the order of arrangement (YES in step S860), it switches the control to step S870. Otherwise (NO in step S860), the CPU 1 ends the control.

In step S870, the CPU 1 assigns a certain degree of importance set in advance to each of the options. For example, the CPU 1 provides the option with a value that is smaller than a minimum value of the degree of importance derived by Expression (1) or Expression (2), or a value that is greater than a maximum value of the derived degree of importance.

[Screen]

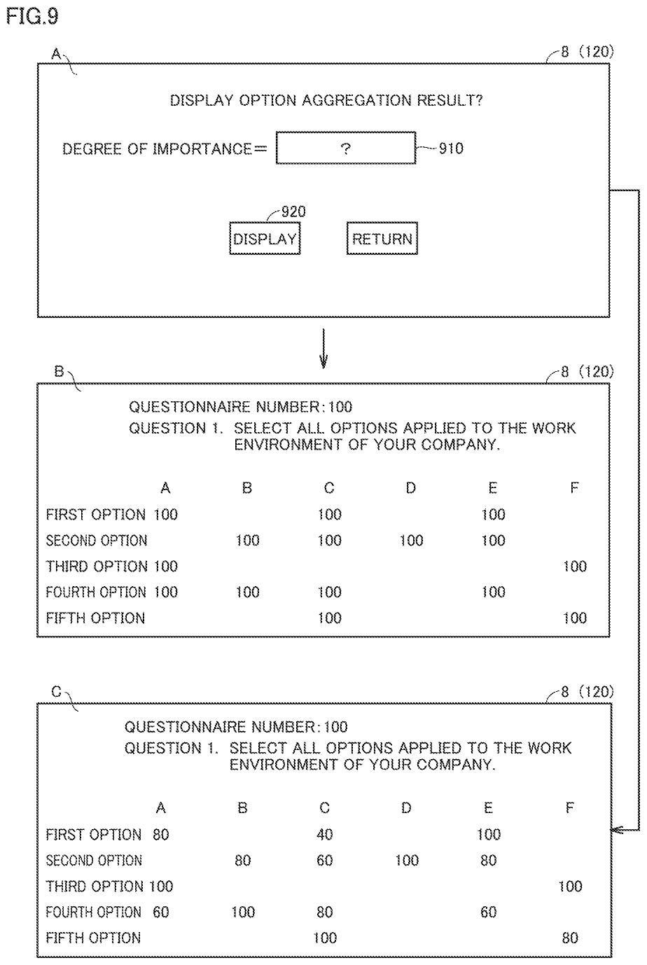

A display of the aggregation result of the questionnaire will be described with reference to FIG. 9. FIG. 9 is a diagram illustrating transition of screens displayed on the terminal 120 used by a user (e.g., a research company, a business company, or another company) of the questionnaire aggregation service.

Screen A represents an initial screen to be displayed on the monitor 8 of the terminal 120. The monitor 8 displays a region 910. The region 910 receives the presence or absence of the designation of the degree of importance, and the designation of an item selectable as the degree of importance when the designation is present. According to the above example, the item is a selection order or a selection time. When the user performs input to the region 910 and presses a display button 920, the terminal 120 transmits the input information to the questionnaire aggregation apparatus 130.

In response to the information, the questionnaire aggregation apparatus 130 aggregates the answers to the questionnaire and transmits the aggregation result to the terminal 120. For example, in a case where the user performs an input for instructing the display of the answer result to the questionnaire on the region 910, Screen A is switched to Screen B. On the other hand, in a case where the user performs an input for instructing the display of the result in which the degree of importance is considered for the result of the questionnaire on the region 910, Screen A is switched to Screen C.

Screen B displays the aggregation result of the answers to the questionnaire. This aggregation result is not weighted, unlike the degree of importance, and a certain numerical value (=100) is given to the selected option.

Screen C displays a result in which the degree of importance is considered based on the item specified for the answer to the questionnaire. Screen C displays a result when the selection order is designated as the degree of importance. In another aspect, by returning to Screen A and designating another item, the user can request the questionnaire aggregation apparatus 130 for a result in consideration of another degree of importance (for example, selection time).

### Effects of the Embodiment

As described above, according to the present embodiment, in a questionnaire including a multiple-option question in which an answer is selected from two or more options, the degree of importance is calculated based on how a respondent answers. By doing so, it is possible to weight each of the selected options, and it is possible to obtain an answer result in a form in which the degree of importance felt by the respondent is reflected.

It should be understood that the embodiments disclosed herein are illustrative and non-restrictive in every respect. The scope of the present invention is defined not by the above description but by the appended claims and is intended to include any modifications within the scope and meaning equivalent to the appended claims.

### INDUSTRIAL APPLICABILITY

The disclosed technical features can be used for, for example, a computer system that aggregates results of a questionnaire executed online.

Although embodiments of the present invention have been described and illustrated in detail, the disclosed embodiments are made for purposes of illustration and example only and not limitation. The scope of the present invention should be interpreted by terms of the appended claims.

What is claimed is:

1. An information processing method to be executed by a computer, the method comprising:
accessing
a questionnaire answer consisting of one or more options selected from a plurality of options prepared in advance as answers to each of a plurality of questions, and
information recorded as a selection manner in which the one or more options are selected; and
calculating a degree of importance of each of the selected one or more options, based on the information recorded as the selection manner.

2. The information processing method according to claim 1, wherein
the information recorded as the selection manner is a selection order in which the one or more options are selected, and
calculating the degree of importance includes calculating the degree of importance such that a degree of importance of an option selected earlier is higher than a degree of importance of an option selected later.

3. The information processing method according to claim 1, wherein
the information recorded as the selection manner is a time taken for each of the one or more options to be selected, and
calculating the degree of importance includes calculating the degree of importance such that a degree of importance of an option for which the taken time is shorter is higher than a degree of importance of an option for which the taken time is longer.

4. The information processing method according to claim 1, wherein calculating the degree of importance includes setting a degree of importance of an option selected after selection and cancellation of the selection are repeated, lower than a degree of importance of a selected option other than the option selected after selection and cancellation of the selection are repeated.

5. The information processing method according to claim 1, wherein when each of a plurality of options is selected in an order in which the options are arranged, calculating the degree of importance includes skipping the calculating the degree of importance of the selected options.

6. The information processing method according to claim 1, further comprising:
reflecting the degree of importance on the questionnaire answer; and
outputting the questionnaire answer on which the degree of importance is reflected.

7. The information processing method according to claim 1, further comprising:
causing a terminal accessing the computer to display each of the plurality of questions and the plurality of options prepared in advance as answers to each of the questions; and
receiving, from the terminal, the information recorded as the selection manner in which the one or more options are selected.

8. The information processing method according to claim 7, wherein causing the terminal to display includes causing one screen of the terminal to display all options to one question.

9. The information processing method according to claim 1, further comprising excluding an option from options for which the degree of importance is calculated, based on a fact that the time taken for the option to be selected is a predetermined time or less.

10. A questionnaire aggregation apparatus comprising:
a memory to store a plurality of instructions; and
a processor to execute the plurality of instructions,
the plurality of instructions, when executed by the processor, causing the processor to perform:
accessing
a questionnaire answer consisting of one or more options selected from a plurality of options prepared in advance as answers to each of a plurality of questions, and
information recorded as a selection manner in which the one or more options are selected; and
calculating a degree of importance of each of the selected one or more options, based on the information recorded as the selection manner.

11. The questionnaire aggregation apparatus according to claim 10, wherein
the information recorded as the selection manner is a selection order in which the one or more options are selected, and
calculating the degree of importance includes calculating the degree of importance such that a degree of importance of an option selected earlier is higher than a degree of importance of an option selected later.

12. The questionnaire aggregation apparatus according to claim 10, wherein
the information recorded as the selection manner is a time taken for each of the one or more options to be selected, and
calculating the degree of importance includes calculating the degree of importance such that a degree of importance of an option for which the taken time is shorter is higher than a degree of importance of an option for which the taken time is longer.

13. The questionnaire aggregation apparatus according to claim 10, wherein calculating the degree of importance includes setting a degree of importance of an option selected after selection and cancellation of the selection are repeated, lower than a degree of importance of a selected option other than the option selected after selection and cancellation of the selection are repeated.

14. The questionnaire aggregation apparatus according to claim 10, wherein when each of a plurality of options is selected in an order in which the options are arranged, calculating the degree of importance includes skipping the calculating the degree of importance of the selected options.

15. The questionnaire aggregation apparatus according to claim 10, wherein the plurality of instructions further cause the processor to perform:
reflecting the degree of importance on the questionnaire answer; and
outputting the questionnaire answer on which the degree of importance is reflected.

16. The questionnaire aggregation apparatus according to claim 10, wherein the plurality of instructions further cause the processor to perform:
causing a terminal accessing the questionnaire aggregation apparatus to display each of the plurality of questions and the plurality of options prepared in advance as answers to each of the questions; and
receiving, from the terminal, the information recorded as the selection manner in which the one or more options are selected.

17. The questionnaire aggregation apparatus according to claim 16, wherein causing the terminal to display includes causing one screen of the terminal to display all options to one question.

18. The questionnaire aggregation apparatus according to claim 10, wherein the plurality of instructions further cause the processor to exclude an option from options for which the degree of importance is calculated, based on a fact that the time taken for the option to be selected is a predetermined time or less.

19. A non-transitory computer-readable information recording medium storing a plurality of instructions, the plurality of instructions, when executed by a processor, causing the processor to perform:
accessing
a questionnaire answer consisting of one or more options selected from a plurality of options prepared in advance as answers to each of a plurality of questions, and
information recorded as a selection manner in which the one or more options are selected; and
calculating a degree of importance of each of the selected one or more options, based on the information recorded as the selection manner.

20. The computer-readable information recording medium according to claim 19, wherein
the information recorded as the selection manner is a selection order in which the one or more options are selected, and
calculating the degree of importance includes calculating the degree of importance such that a degree of importance of an option selected earlier is higher than a degree of importance of an option selected later.
